(19) United States
(12) Patent Application Publication
(10) Pub. No.: US 2008/0150188 A1
(43) Pub. Date: Jun. 26, 2008

(54) Method And Device For Producing A Molded Plastic Part

(76) Inventors: Claus Hetzner, Zirndorf (DE); Robert Hiesinger, Burgheim (DE)

Correspondence Address: ST. ONGE STEWARD JOHNSTON & REENS, LLC, 986 BEDFORD STREET, STAMFORD, CT, 06905-5619, US

(21) Appl. No.: 11/958,023

(22) Filed: Dec. 17, 2007

(30) Foreign Application Priority Data
Dec. 22, 2006 (DE) 10 2006 061 059.8

(51) Int. Cl. B29C 47/06

(52) U.S. Cl. 264/150; 264/249; 425/112

(57) ABSTRACT

The invention relates to a method for producing a molded plastic part, including the steps of: spraying a quasi-endless plastic tube with an annular gap of a spray head; shaping and at least partially cooling the plastic tube with a molding line connecting to the spray head. In particular, the molding line includes a number of recirculation molding jaws, the molded plastic part is configured as a repeat unit of the plastic tube shaped by the molding jaws.

### CROSS-REFERENCE TO RELATED APPLICATIONS

The present application claims priority of German patent application No. 10 2006 061 059.8 filed on Dec. 22, 2006, the content of which is incorporated herein by reference.

### FIELD OF THE INVENTION

The invention relates to a method for producing a plastic molded part, in which a quasi-endless plastic tube is sprayed by means of an annual gap in a spray head. The invention also relates to a device for producing a molded plastic part according to the generic terms of Claim 10. In addition the invention relates to a molded plastic part that is produced by an inventive method and/or through an inventive device, and to the use of a device for producing a plastic tube for producing molded plastic parts according to the characteristics of Claim 20.

### BACKGROUND OF THE INVENTION

EP 1 243 400 B1 describes a device for producing corrugated tubes in which a plastic heated for fluidity is pressed by means of an extruder through a first and a second annular gap of a spray head, so that a two-layered plastic tube is produced. The plastic tube at first extends with its interior through a calibration and is then pressed onto the inside wall of molding jaws that grip outwards, so that a plastic tube with outside corrugated fins and a smooth internal surface is formed. To be able to produce an endless or quasi-endless plastic tube, the molding jaws are a component of a molding line in which several successively positioned molding jaws are moved together with a plastic tube and then are conducted back through a recirculation mechanism to the start of the molding line.

Also known in the art are plug-in sleeves and double plug-in sleeves for plastic corrugated tubes, which include a collar with a smooth cylindrical inside wall, which can be pushed through one end of a plastic corrugated tube. Here one or more insulating rings can b inserted into the fins of the corrugated tube in order to produce an insulated connection between the plug-in sleeves and the plastic tube. Plug-in sleeves of this type are primarily produced with other forming methods for plastic than the corrugated tube itself. Special production machines are accordingly employed for this purpose.

It is the object of the invention to reduce complexity and costs in the production of molded plastic parts.

### SUMMARY OF THE INVENTION

This object is achieved for an aforementioned production method for producing a molded plastic part according to the invention with the characteristics of Claim 1. The production of molded plastic parts by means of a molding line with recirculating molding jaws connecting to a spray head with annular gap results in a quasi-endless plastic tube, in segments of which successive molded plastic parts are shaped. After the production of the plastic tube with the embedded molded plastic parts, these parts can be split off as repeat units of the plastic tube, so that the final result is the molded plastic part that is to be produced. Such a production method can especially save on complexity and costs if a corresponding production machine with molding line with recirculating molding jaws is available and is used, for instance, for producing plastic tubes, especially corrugated plastic tubes.

In a preferred embodiment of the method, the molded plastic parts include a plug-in sleeve, which in particular can be inserted into one end of a corrugated tube. The plug-in sleeve can be configured especially favorably as a double plug-in sleeve. Thus, by simply exchanging of the molding jaws by means of the same machine it is possible, for one thing, to produce an endless corrugated plastic tub and, for another thing, to make plug-in sleeves that fit this corrugated tube.

In a generally advantageous manner, in the course of the splitting according to Step c, an intermediate part can be split off which is configured as an offcut positioned in successive repeat units or final molded plastic parts. Such an intermediate part can in particular include a bead. As a result the process of splitting can be simplified and/or optimized. The bead here, for instance, can constitute a reinforcement that makes possible a simple and precise severing of the molded plastic part from the quasi-endless plastic tube.

In an especially preferred embodiment, the molded part is configured by two successive molding jaws of the molding line. Basically, however, it is also possible to configure a number of successive molding parts in one molding jaw, or also to shape more than two molding jaws altogether for configuring an individual molded plastic part, or else for precisely one molding jaw in each case to correspond to a molded plastic part or to a repeat unit.

In a preferred refinement of the invention, the plastic tube can be treated from inside with a gas with an adjustable pressure. As a result, the plastic tub while still in its soft condition can be pressed in defined manner from inside onto the molding jaws. Alternatively or as a supplement, the areas between the molding jaws and the outer wall of the plastic tube can be capable of evacuation in order to cause contact of the soft plastic tube against the shaping configurations of the molding jaws by means of negative pressure.

In addition to the pressure impact, in order to allow an adjustable, effective cooling of the plastic tube, the gas can advantageously be irrigated at a controlled flow rate. This can be accomplished preferably and simply by means of a controllable valve.

In an additional advantageous embodiment, a second plastic layer of the plastic tube is sprayed by means of a second annular gap of the spray head. The plastics here can be diverse or also of the same plastic material with various amounts of additives or dye pigments or the like. As a result, the design, mechanical, and chemical qualities of the molded plastic part can be optimized by multi-layered configuration. It becomes possible to do so in especially simple and cost-saving manner if the spray head, because of the alternative use of the production device, comprises in any case two or more annular gaps for producing tubes with several layers.

The object of the invention calling for an aforementioned device to produce a molded plastic part is achieved according to the invention with the identifying characteristics of Claim 10. The inventive production device can advantageously serve, first, to produce molded plastic parts especially according to the method of Claim 1 and, second, to produce plastic tubes, especially corrugated plastic tubes. The production of corrugated plastic tubes by means of such a device is known per se, for instance through document EP 1 243 400 B1.

The molded plastic part is preferably a plug-in sleeve, and especially advantageously a double plug-in sleeve for a tube. This is especially appropriate if the tube that it is to fit the plug-in sleeve or double plug-in sleeve, for instance a corrugated tube, is produced on the same production device, where it is essentially only the molding jaws that must be exchanged in order to produce either a quasi-endless succession of final molded plastic parts or a quasi-endless plastic tube.

It is generally advantageous if the device includes an insulating agent downstream of the annual gap that can move by sliding from inside on the plastic tube. A space set off by the insulating agent thus can be advantageously impacted, through a connecting line, by a gas under defined pressure. In an advantageous refinement, in addition a volume flow of the gas through the space can be adjusted by means of a regulating member. Said regulating member can include in particular an adjustable valve positioned in the area of the insulating agent. Altogether, as a result, the production process of the quasi-endless tube with the successive molded plastic parts can be optimized in a simple manner in that, first, the force pressure of the tube against the molding jaws can be regulated and, second, a cooling capacity can be adjusted by the through-flowing gas of defined temperature.

In an especially preferred embodiment the spray head comprises a second annular gap. This makes it totally possible that the second annular gap does not contribute to the production of the molded plastic part but rather to the alternative production of a plastic tube on the same production device.

Likewise it can be advantageous to provide that, downstream from the spray head, a calibration is mounted that is surrounded by the plastic tube so that in particular the calibration is not touched by the plastic tube. As a result the calibration does not contribute to the production of the molded plastic parts, yet it can usefully be employed for the production of a plastic tube on the same device in a method that is known per se. The calibration in appropriate cases can also touch the plastic tube in the course of producing molded plastic parts.

The object of the invention is fulfilled for a molded plastic part with the characteristics of Claims 18 and 19.

In addition, the object of the invention is fulfilled by the use of a device for producing a plastic tube for producing molded plastic parts according to the characteristics of Claim 20. By using the same device for producing essentially different parts, a quasi-endless plastic tub on the one hand and a final molded plastic part on the other hand, considerable costs can be saved. In particular, it is possible to avoid the acquisition of special machines for producing molded plastic parts. Essentially only appropriate molding jaws are needed which are exchanged for the molding jaws of a device for producing a plastic tube.

A particularly appropriate and cost-saving combination of producible parts is available if the plastic tube is configured as a corrugated tube, in particular with at least two layers. The molded plastic part here is preferably configured as a plug-in sleeve, especially a double plug-in sleeve. The plug-in sleeve is especially preferably configured for application onto the plastic tube that can be produced by the device. Here the particular diameters of the tube and molded part or plug-in sleeve fit to one another in simple manner, without requiring central parts of the production device, such as the spray head, to be modified.

It is fundamentally rather costly to produce molded plastic parts with a device for the production of corrugated plastic tubes, in comparison to known measures. If such a machine is available for the production of corrugated plastic tubes, however, then considerable costs can be saved, particularly if one bears in mind that producers of corrugated plastic tubes regularly require corresponding accessory parts for these corrugated tubes, such as plastic plug-in sleeves. The quantity of such accessory parts to be produced for the corrugated tubes is relatively small in proportion to the material quantity of the corrugated tubes, so that the use of the device to produce the corrugated tubes for the production of the accessory parts according to the inventive method and devices constitutes a considerable cost reduction. This is especially due to the fact that by using the non-specialized and expensive but at least available machine it is possible to avoid acquiring special machinery.

Further advantages and characteristics of the invention can be seen from the embodiment described hereafter as well as from the corresponding claims.

Hereafter a preferred embodiment of the invention is described and further explained with reference to the appended illustrations.

### BRIEF DESCRIPTION OF THE DRAWINGS

FIG. 1 shows a schematic overhead view with partly sectional view of a device according to the invention.

FIG. 2 shows an overhead view of a molded plastic part according to the invention.

FIG. 3 shows a quasi-endless plastic tube with successive molded parts according to the invention.

FIG. 4 shows a detailed enlargement of the device of FIG. 1 in a different operating mode.

### DETAILED DESCRIPTION OF THE INVENTION

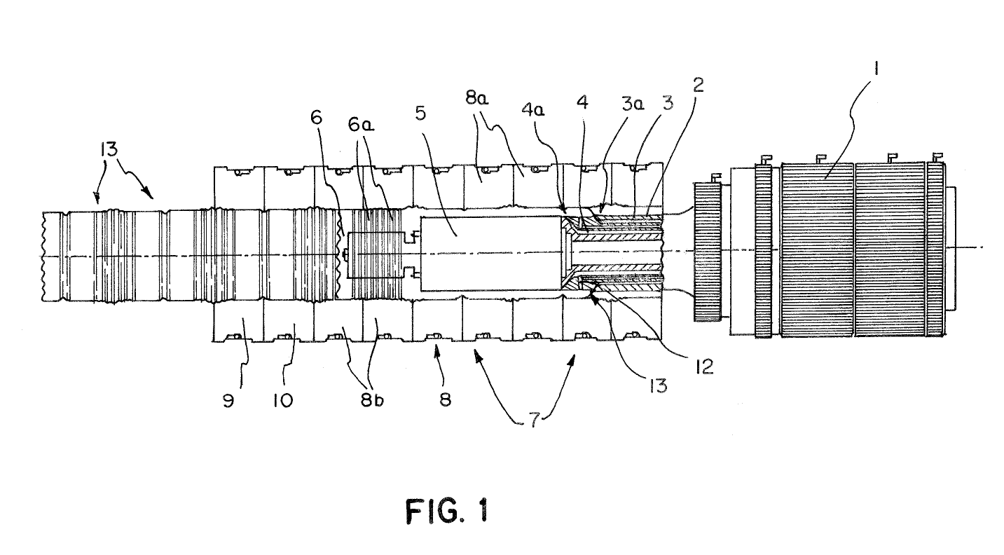

The device shown in FIG. 1 includes an extruder unit 1, through which one or more thermoplastic plastics in fluid state are delivered under pressure to a spray head 2. The spray head 2 includes primarily a first feeder channel 3 with a ring-shaped outlet gap 3a 360 degrees around it and a second feeder channel 4 with a likewise ring-shaped outlet gap 4a.

A calibration 5 is attached to the spray head. After the calibration 5 in the delivery direction of the plastic there follows an insulating agent 6, which includes a number of elastic insulating discs 6a.

Positioned to surround the spray head, the calibration 5, and the insulating agent 6 is a molding line 7 with a number of movable molding jaws 8. The molding jaws 8 each have a left molded jaw half 8a and a right molding jaw half 8b, which come together to form an axially symmetrical molding segment of the molding line 7.

The molding jaws 8 or molding jaw halves 8a, 8b are moved together in the delivery direction of the plastic (from right to left in the presentation in FIG. 1), which occurs by means of an operating and delivery mechanism that is not illustrated. At the end of the molding line 7 the molding jaw halves 8a and 8b are each rotated radially from the formed and at this point sufficiently hardened plastic and moved back on the outside to the start of the molding line. Such a molding line as a device for producing multi-layered corrugated tubes is known per se; see for instance EP 243 400 B1.

In the inventive device according to FIG. 1 there are essentially two types of molding jaws 9, 10, which are positioned alternatingly in succession in the molding line. The molded objects of the molding jaw of the first type 9 and of the molding jaw of the second type 10, which objects are facing the plastic, together form the negative shape of the axially symmetrical outer surface of a molded plastic part.

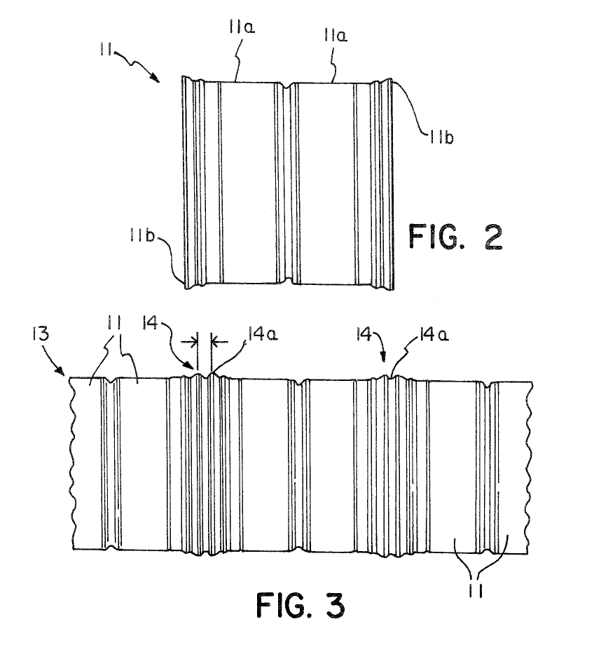

The molded plastic part is primarily a double plug-in sleeve 11, as shown in FIG. 2. The inventive double plug-in sleeves 11 are configured as mirror-symmetrical in relation to a middle layer and have each cylindrical wall segments a, with which they are moved in sliding motion over the ends of a corrugated tube until the corrugated tube ends encounter a central bead of the plug-in sleeve as a boundary. To simplify the sliding onto the corrugated tube, the wall segments 11a toward the ends have a conical outcropping 11b. To insulate the plug-in sleeves 11 on the ends of the corrugated tube, the corrugated tubes can be equipped with O-ring insulations. This can be done in simple manner if an elastic O-ring is inserted in the corrugated trench in the attachment area of a corrugated tube, so that the plug-in sleeve 11 is pushed down onto the O-ring for insulation.

The plastic exiting in fluid form from the first annular gap 3a is at first in the form of an unformed, soft plastic tube 13. By means of a feeder line 12 configured in the spray head 2, a gas such as air is conducted into the inside of the plastic tube, so that on account of the plastic tube 13, the spray head 2, and the insulating agent 6, a closed space is formed, which is pressure-impacted by the gas. Because of the impacted pressure, the soft plastic tube 13 is pressed from inside onto the moving molding jaws 8 of the molding line 7. The speed of the molding jaws 8 thus corresponds essentially to the exit speed of the plastic tub out of the annular gap 3a.

As an alternative or complement, it is possible to provide channels for evacuation of the air situated between the plastic tube 13 and the inside surface of the molding jaws 8, so that the plastic tube 13 can be put in contact with the wall or shaping of the molding jaws 8 using negative pressure either in support or exclusively.

In particular in the area of the insulating agent 6, a regulatable control valve (not illustrated) can be provided to enable the gas conducted through the channel 12 to be released at a controlled rate. In this way a volume flow of the gas can be adjusted independently of the adjusted pressure, making it possible to achieve an improved, and in particular regulatable, cooling of the inside of the plastic tube 13 that contacts the molding jaws.

Both through contact with the gas and through contact with the walls of the molding jaws 8, the plastic tube 13 cools down in the course of transport in the delivery direction (from right to left, as in FIG. 1) and becomes firm. In this way a quasi-endless plastic tube 3 is produced, which consists basically of any number of successive molded plastic parts 11 of final length in each case (see FIGS. 1 and 3).

In a succeeding step of the procedure (not illustrated here), the molded plastic parts are severed from the quasi-endless plastic tube 13 in order to produce individual, final long molded plastic parts 11 as illustrated in FIG. 2.

FIG. 3 shows a segment of the shaped and hardened plastic tube with molded parts 11 not yet severed. Between successive molded parts 11, there is an intermediate part 14 in each case, which includes a bead-shaped indentation 14a. The intermediate part 14 between two adjacent molded parts 11 is sawed off as excess. The molded parts 11 are severed here by means of a surrounding saw instrument, which includes a double blade, which attacks the bulge or edges of the molded parts 11 close to the bead 14a. Because of the bead any yielding of the material of the plastic tube 13 at the contact point of the saw blades is avoided, so that the severing process can proceed cleanly and in controlled manner.

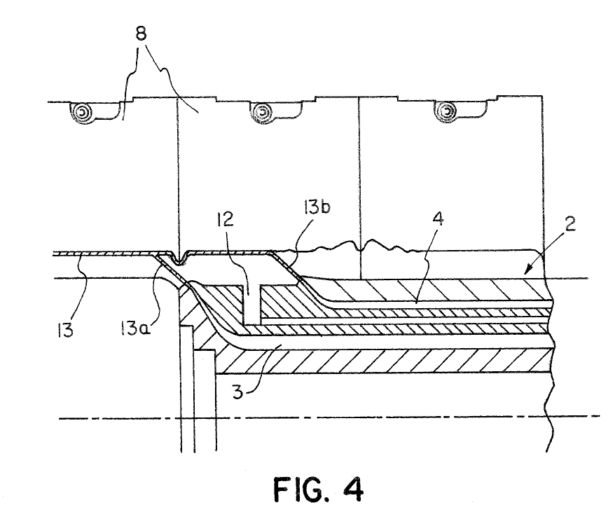

FIG. 4 shows a detail view of the same device as in FIG. 1, but in both channels 3, 4 plastic is supplied so that the plastic tube 13 is composed of a first, inside layer 13a and a second, outer layer 13b. Here the material of the two layers 13a, 13b can be different in order to fulfill any corresponding requirements placed on the molded plastic part.

In the described production method for a molded plastic part 11, the calibration 5 of the production device in particular is not used. The calibration 5 is a component of the device because said device is regularly used for producing corrugated plastic tubes with at least two layers, so that the outer layer of the plastic tube receives corrugated fins by means of appropriate molding jaws that are exchanged with the illustrated device and the inside layer, which runs through the calibration 5, forms a smooth inside wall of the corrugated tube. Thus there is no essential difference—even down to the different configuration of the molding jaws 8—between the device for producing a corrugated tube with smooth inside surface and the illustrated device for producing a molded plastic part. Therefore, because of the exchange of the molding jaws 8 of the molding line 7, the device for producing a corrugated tube with smooth inside surface can be modified in a simple manner and economically in order to produce molded plastic parts, primarily double plug-in sleeves 11.

1. A method for producing a molded plastic part, including:
a. Spraying of a quasi-endless plastic tube by means of an annular gap of a spray head;
b. Forming and at least partial cooling of the plastic rube by means of a molding line connecting to the spray head, where the molding line includes a number of recirculation molding jaws and the molded plastic part is configured as a repeat unit of the plastic tube shaped by the molding jaws; and
c. Severing of at least one of the repeat units from the shaped plastic tube as a molded plastic part.

2. A method according to claim 1, characterized in that the molded plastic part includes a plug-in sleeve, which in particular can be plugged onto an end of a corrugated tube.

3. A method according to claim 2, characterized in that the plug-in sleeve is configured as a double plug-in sleeve.

4. A method according to claim 1, characterized in that in the course of the severing according to step c, an intermediate part is severed, which is configured as an excess positioned between two successive repeat units.

5. A method according to claim 4, characterized in that the intermediate part includes a bead.

6. A method according to claim 1, characterized in that the molded part is configured by two successive molding jaws of the molding line.

7. A method according to claim 1, characterized in that the plastic tube is impacted from inside with a gas having adjustable pressure.

8. A method according to claim 4, characterized in that the gas with a controlled flow-through rate is irrigated, in particular by means of a controllable valve.

9. A method according to claim 1, characterized by spraying of a second plastic layer of the plastic tube by means of a second annular gap of the spray head.

10. Device for producing a molded plastic part, including a spray head with at least one annular gap, and a molding line mounted downstream of the spray head, where the molding line includes a number of recirculating molding jaws, characterized in that the molded part can be configured in a shape of at least one part of at least one of the molding jaws, where by means of the recirculation of the molding jaws a quasi-endless plastic tube can be configured with plastic parts in succession that are connected as one piece.

11. A device according to claim 10, characterized in that the molded plastic part is a plug-in sleeve, in particular a double plug-in sleeve for a tube.

12. A device according to claim 10, characterized in that the device includes an insulating agent mounted downstream of the annular gap that moved by sliding from inside on the plastic tube.

13. A device according to claim 12, characterized in that a space bounded by the insulating agent is impacted with a gas under defined pressure through a feeder line.

14. A device according to claim 12, characterized in that a volume flow of the gas through the space can be adjusted by means of a regulating member.

15. A device according to claim 14, characterized in that the regulating member includes a controllable valve positioned in the area of the insulating agent.

16. A device according to claim 10, characterized in that the spray head includes a second annular gap.

17. A device according to claim 10, characterized in that a calibration surrounded by the plastic tube is mounted on the spray head, so that in particular the calibration is not touched by the plastic tube.

18. A molded plastic part, produced by a method according to claim 1.

19. A molded plastic part, produced by means of a device according to claim 11.

20. Use of a device for producing a plastic tube to produce molded plastic parts,
wherein the device includes a spray head with at least one annular gap and a molding line mounted downstream of the spray head with a number of recirculation molding jaws,
wherein the molded plastic parts can be severed individually from a molded plastic tube,
wherein at least one of the molding jaws for producing a plastic tube is exchanged with a molding jaw for producing the molded plastic part.

21. Use of the device according to claim 20, characterized in that the plastic tube is configured as a corrugated tube, especially one with at least two layers.

22. Use of the device according to claim 20, characterized in that the molded plastic part is a plug-in sleeve, in particular a double plug-in sleeve.

23. Use of the device according to claims 22, characterized in that the plug-in sleeve is configured to be imposed on the plastic tube that can be produced by the device.
